(19) United States
(12) Patent Application Publication
(10) Pub. No.: US 2005/0005957 A1
(43) Pub. Date: Jan. 13, 2005

(54) Cleaning apparatus for cleaning objects to be treated with use of cleaning composition

(75) Inventors: Masahiro Yamagata, Takasago-shi (JP); Hisanori Oshiba, Takasago-shi (JP); Yoichi Inoue, Takasago-shi (JP); Yusuke Muraoka, Kyoto-shi (JP); Tomomi Iwata, Kyoto-shi (JP); Kimitsugu Saito, Kyoto-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: KABUSHIKI KAISHA KOBE SEIKO SHO, Kobe-shi (JP); DAINIPPON SCREEN MFG. CO., LTD., Kyoto-shi (JP)

(21) Appl. No.: 10/886,629

(22) Filed: Jul. 9, 2004

(30) Foreign Application Priority Data
Jul. 11, 2003 (JP) 2003-273587

(51) Int. Cl. B08B 3/00

(52) U.S. Cl. 134/200

(57) ABSTRACT

Provided is a cleaning apparatus for cleaning an object to be treated by contacting the object to be treated with a high pressure fluid of a cleaning composition containing a cleaning component as an essential ingredient. The cleaning apparatus includes high pressure fluid supplying means for supplying the high pressure fluid of the cleaning composition, a high pressure washing vessel for removing unnecessary materials deposited on the object to be treated by contacting the object to be treated with the high pressure fluid of the cleaning composition therein, a storing vessel for storing a waste high pressure fluid of the cleaning composition carrying the unnecessary materials therein, and a sealed structure for sealably housing the high pressure fluid supplying means, the high pressure washing vessel, and the storing vessel therein. The sealed structure has first exhaust means for exhausting the gas remaining in the sealed structure therefrom.

### BACKGROUND OF THE INVENTION

1. Field of the Invention

The present invention relates to an apparatus for cleaning microstructures having asperities (protrusions and recesses) such as semiconductor wafers, as objects to be treated.

2. Description of the Related Art

It is indispensable to remove unnecessary materials deposited on semiconductor wafers in a process of manufacturing semiconductor wafers. For instance, there is often used a step of forming patterns on semiconductor wafers with use of photoresist. The photoresist used in a masking step becomes unnecessary after an etching step, and is removed by carrying out oxygen plasma ashing or a like technique (an ashing step). After the ashing step, it is required to carry out a washing step of stripping and removing, from the wafer surfaces, unnecessary materials such as etching residues, and photoresist residues that have not been removed by the ashing step. The washing step is a crucial step in the semiconductor manufacturing process, because it is a frequently-performed step in the semiconductor manufacturing process, not to mention after the ashing step.

In recent years, a study has been progressed regarding use of carbon dioxide in a liquid state or a supercritical state (hereinafter, simply called as “high-pressure carbon dioxide”), as a washing or rinsing medium such as a washing or rinsing solution in the washing step. Since the high-pressure carbon dioxide has superior penetrating ability with a low viscosity, it easily penetrates into fine patterns and exhibits high cleaning performance, as compared with a wet cleaning method of using water as a washing medium. In addition, since the high-pressure carbon dioxide can dry the objects to be treated without generating a gas-liquid boundary interaction, there is no likelihood that the etched patterns may collapse due to capillary force.

Despite the merit that the high-pressure carbon dioxide functions as a low-viscosity solvent, it does not exhibit sufficient solubility of dissolving unnecessary materials, and does not provide satisfactory cleaning performance, if used alone. In view of this, there is proposed a technique of raising cleaning performance by high pressure carbon dioxide in a washing step, as disclosed in Japanese Patent No. 2574781, for instance. The publication recites a technique of raising mutual solubility of dissolving contaminants, as well as a supercritical fluid or a liquefied fluid by admixing a small amount of an organic solvent, acid, alkali compound, or the like into the supercritical fluid or the liquefied fluid, as a third component, in a step of contacting the supercritical fluid or the liquefied fluid with the contaminants deposited on semiconductor substrates to extract the contaminants into the supercritical fluid or the liquefied fluid. In the publication, carbon dioxide is used as an example of the supercritical fluid or the liquefied fluid, and hydrogen fluoride is used as an example of the acid.

The inventors found a method of adding a basic substance as a cleaning component, and adding an alcohol as a compatible agent to dissolve the basic substance, as a technique of raising cleaning performance in using high-pressure carbon dioxide as a solvent in a washing step, and filed a patent application reciting the method (see Japanese Unexamined Patent Publication No. 2002-237481). As a further study has been carried out, however, there has been found a drawback that cleaning semiconductor wafers formed with an interlayer insulation film made of a low-k dielectric material (so-called “low-k film”), which have been heavily used recently, by a supercritical fluid containing a basic substance may degrade the quality of the semiconductor wafers. It is conceived that such a drawback occurs because the cleaning component etches the low-k film having an analogous composition to resist residues, thus damaging the low-k film and deforming the fine patterns formed on the low-k film.

In view of the above, the inventors found that use of hydrogen fluoride as a cleaning component is effective to efficiently remove unnecessary materials such as resist residues in cleaning microstructures without giving damages to the necessary substances on the semiconductor wafers particularly formed with the low-k film or a like structure, and filed a patent application reciting the finding (see Japanese Patent Application No. 2002-320941). However, hydrogen fluoride to be admixed to the high-pressure carbon dioxide is harmful to living things even in the concentration order of ppm, and has corrosive behavior. Accordingly, there rises a need of strictly controlling the hydrogen fluoride, so that the hydrogen fluoride may not leak from the cleaning apparatus. In addition, it is required to make an area where the cleaning apparatus is installed corrosion-resistant, which raises the cost relating to manufacturing of semiconductor wafers. Further, there should be considered a case that a harmful material other than the hydrogen fluoride may be contained as a cleaning component, and a case that a material which may become harmful by reaction with the resist, the low-k film, or the like may be contained as a cleaning component. Therefore, a strict control is required, so that such harmful or possible harmful materials may not leak from the cleaning apparatus.

### SUMMARY OF THE INVENTION

In view of the above, it is an object of the present invention to provide a cleaning apparatus that enables to minimize contamination due to leakage of harmful materials therefrom to thereby suppress adverse effect on human beings due to the contamination, wherein the cleaning apparatus is so constructed as to remove unnecessary materials deposited on objects to be treated for cleaning by contacting the objects to be treated with a high pressure fluid of a cleaning composition containing a cleaning component as an essential ingredient.

According to an aspect of the present invention, a cleaning apparatus for cleaning an object to be treated by contacting the object to be treated with a high pressure fluid of a cleaning composition containing a cleaning component as an essential ingredient comprises: high pressure fluid supplying means for supplying the high pressure fluid of the cleaning composition; a high pressure washing vessel for removing unnecessary materials deposited on the object to be treated by contacting the object to be treated with the high pressure fluid of the cleaning composition therein; a storing vessel for storing a waste high pressure fluid of the cleaning composition carrying the unnecessary materials therein; and a sealed structure for sealably housing the high pressure fluid supplying means, the high pressure washing vessel, and the storing vessel therein. The sealed structure includes first exhaust means for exhausting a gas remaining in the sealed structure therefrom.

These and other objects, features and advantages of the present invention will become more apparent upon reading of the following detailed description along with the accompanying drawings.

### BRIEF DESCRIPTION OF THE DRAWINGS

FIG. 1 is an illustration exemplifying a cleaning apparatus in accordance with a first embodiment of the present invention.

FIG. 2 is an illustration exemplifying a cleaning apparatus in accordance with a second embodiment of the present invention.

FIG. 3 is an illustration exemplifying a cleaning apparatus in accordance with a third embodiment of the present invention.

FIG. 4A is an illustration exemplifying a cleaning apparatus in accordance with a fourth embodiment of the present invention.

FIGS. 4B and 4C are illustrations showing modifications of volume varying means in the fourth embodiment.

FIG. 5 is an illustration exemplifying a cleaning apparatus in accordance with a fifth embodiment of the present invention.

FIG. 6 is an illustration exemplifying a cleaning apparatus in accordance with a sixth embodiment of the present invention.

FIG. 7 is an illustration exemplifying a cleaning apparatus in accordance with a seventh embodiment of the present invention.

FIG. 8 is a perspective view showing an example of an external appearance of a high pressure washing vessel in a washing section of the cleaning apparatus shown in FIG. 7.

FIGS. 9A through 9C are cross-sectional views of the high pressure washing vessel.

FIG. 10 is an illustration exemplifying a cleaning apparatus in accordance with an eighth embodiment of the present invention.

FIG. 11 is an illustration for explaining a state as to how buffer means is connected with a pipe of connecting high-pressure fluid supplying means and a washing section in the eighth embodiment of the present invention.

### DETAILED DESCRIPTION OF THE PREFERRED EMBODIMENTS

Microstructures are defined herein as objects to be treated. Examples of the microstructures serving as objects to be treated in the present invention include a semiconductor wafer with unnecessary materials such as resist residues being deposited on or around an asperity thereof after an ashing.

It is conceived that the resist residues include an inorganic polymeric material obtained by subjecting a resist polymer to an ashing step, a material that is modified by fluorine in an etching gas, a modifier of polyimide or a like compound, which is used as a material for a reflection protective film or the like. The cleaning apparatus of the present invention is suitable for removing resist residues after ashing from objects to be treated for cleaning.

It is needless to say that the inventive cleaning apparatus is not only applicable in removing resist residues from objects to be treated, but also applicable in removing materials to be removed other than the resist residues from semiconductor wafers in a semiconductor wafer manufacturing process. For instance, the inventive cleaning apparatus is usable in removing resist before ashing, as well as resist after ion implantation, and in removing residues formed as micro protrusions on a flat wafer surface after chemical mechanical polishing (CMP).

The site where the material to be removed appears is not limited to the semiconductor wafer surface. Specifically, the inventive cleaning apparatus is useful in removing an interconnect interlayer such as an SiO₂ film and an organic film made of a low-k dielectric material, which is used in forming a microstructure of aerial wiring, as disclosed in Japanese Unexamined Patent Publication No. 2002-231806, and in extracting and removing an unnecessary solvent which remains in a coat of an interlayer insulation film of a low-k dielectric material.

Specifically, the washing step to be implemented by the inventive cleaning apparatus includes a step of removing an interconnect interlayer fabricated in the object to be treated underneath the surface thereof, and a step of dispersing, adsorbing, and removing unnecessary residues in the interconnect interlayer, as well as a step of removing the resist residues.

Further, the term “adhere” as used herein is not limited to the meaning that unnecessary materials are simply deposited on the surface of the objects to be treated, but embraces a meaning that unnecessary materials are dispersed, adsorbed, and remain inside the objects to be treated, namely, embraces a state that unnecessary materials exist in microstructures in a process of manufacturing the same.

Microstructures, i.e., objects to be treated by the inventive cleaning apparatus are not limited to semiconductor wafers, but also include objects in which fine patterns are formed on the surfaces of a variety of kinds of substrates made of a metal, plastic, ceramics, and the like, and materials to be removed are deposited on or remain on the surfaces.

A high pressure fluid of a cleaning composition is used to clean the objects to be treated. Preferably, the cleaning composition contains high pressure carbon dioxide. It is preferable to use high pressure carbon dioxide fluid because the high pressure carbon dioxide fluid has a high diffusing rate, and facilitates dispersing the dissolved unnecessary materials into the cleaning medium. Particularly, use of a supercritical fluid stream of high pressure carbon dioxide is preferable, because the supercritical fluid exhibits a property of an interim state between gas and liquid, and easily penetrates into micro recesses in the objects to be treated. The term “high pressure” as used herein means 5 MPa or higher. Setting a critical temperature to 31° C. or higher, and a critical pressure to 7.4 MPa or higher is preferable to convert carbon dioxide into a supercritical fluid stream of carbon dioxide. It may be possible to carry out cleaning with use of high pressure carbon dioxide fluid stream of 5 MPa or higher and 20° C. or higher, because the high pressure carbon dioxide fluid exhibits sufficient penetrating ability as a cleaning medium due to its high solubility of dissolving unnecessary materials, and its high diffusing ability of dispersing unnecessary materials, as far as carbon dioxide is treated with the aforementioned temperature and pressure.

It is preferable to carry out the washing step at a temperature ranging from 20 to 120° C. If the cleaning temperature is lower than 20° C., a time required for the cleaning is prolonged, which lowers cleaning efficiency. If the cleaning temperature exceeds 120° C., no more cleaning efficiency is expected, which is a waste of energy. A preferred upper limit of the cleaning temperature is 100° C., and a more preferred upper limit thereof is 80° C. The time required for the cleaning can be optionally changed depending on the size of the objects to be treated, the quantity of contaminants, and other factor. In case that the objects to be treated are semiconductor wafers formed with a low-k film, an exceedingly long cleaning time may damage the film, and lower productivity. In view of this, generally, a preferred cleaning time is 3 minutes or shorter per wafer, and a more preferred cleaning time is 2 minutes or shorter.

As mentioned above, in the inventive cleaning apparatus, a cleaning composition containing a cleaning component as an essential ingredient is used as a cleaning medium in light of the fact that high pressure carbon dioxide does not provide sufficient cleaning performance, if used alone. In the following, an example where hydrogen fluoride is used as the cleaning component is described. It should be noted that the cleaning component to be used in the inventive cleaning apparatus is not limited to the above.

Hydrogen fluoride in combined use with high pressure carbon dioxide can enhance cleaning performance of high pressure carbon dioxide. The cleaning composition may be prepared by supplying hydrogen fluoride gas to the high pressure carbon dioxide, or by mixing hydrofluoric acid, which is an aqueous solution of hydrogen fluoride, with the high pressure carbon dioxide. Use of the hydrofluoric acid is advantageous in facilitating control of the supply amount of the hydrogen fluoride, as compared with a case of supplying hydrogen fluoride gas to the high pressure carbon dioxide, because the concentration of the hydrogen fluoride in the cleaning composition is easily controlled by regulating the amount of the hydrofluoric acid to be mixed with the high pressure carbon dioxide.

It is preferable to add alcohol to the cleaning composition in cleaning semiconductor wafers formed with a low-k film, which is susceptible to damages. This is recommended because alcohol has an action of lessening damages to the low-k film by mitigating the cleaning action of hydrogen fluoride. Further, alcohol has a compatibility action of making it easy to dissolve unnecessary materials, which are inherently hard to be dissolved in the water component of hydrofluoric acid and high pressure carbon dioxide, in the water component and the high pressure carbon dioxide. It is preferable to add 1% or more by mass of alcohol to the cleaning composition, so that the low-k film protecting action and the compatibility action are exhibited. A more preferred lower limit of the alcohol to be added is 2% by mass. An upper limit of the alcohol to be added is not specifically limited. However, an excessive addition of alcohol may resultantly decrease the quantity of high pressure carbon dioxide as a cleaning medium, which makes it difficult to obtain superior penetrating ability of the high pressure carbon dioxide. In view of this, preferably, 20% or lower by mass, and more preferably, 10% or lower by mass of the alcohol is added. The alcohol may be usable in a first rinsing stage of a rinsing step, which follows, the washing step.

Examples of the alcohol include methanol, ethanol, n-propanol, isopropanol, n-buthanol, isobuthanol, diethyleneglycol monomethylether, diethyleneglycol monoethylether, and hexafluoro isopropanol.

Examples of the low-k film which is suitable to be cleaned by the inventive cleaning apparatus include: hybrid type low-k films based on methylsilsesquioxane such as JSRLKD series produced by JSR Corporation; Si-based low-k films produced by chemical vapor deposition (CVD) such as “Black Diamond” produced by Applied Materials, Inc; and organic low-k films such as SILK® produced by Dow Chemical, Inc., and FLARE® produced by Honeywell, Inc. Any other low-k films produced by a spin-on technique, a CVD method, or a like technique may be usable. The inventive cleaning apparatus is also applicable to cleaning porous films (porous type films).

As mentioned above, a preferred example of the cleaning composition used by the inventive cleaning apparatus is carbon dioxide containing hydrofluoric acid and alcohol. It is possible that a harmful material may be contained in addition to the hydrofluoric acid and the alcohol. Examples of possible harmful materials are: (1) a toxic fluid of an allowable concentration limit of 200 ppm or less; (2) a fluid having a lower explosion limit of 10 volumetric % or less; (3) a flammable fluid having a difference between an upper explosion limit and a lower explosion limit of 20 volumetric % or more; (4) a material that is usable as an admixture to carbon dioxide, exhibits a solid state at ambient or room temperature, and has toxicity, for example, which is 500 mg/kg or less in terms of lethal dose (LD) 50; and (5) a material labeled with health hazard class 2 or higher, substantially corresponding to LD 50, which is defined by National Fire Protection Association (NFPA, organization in U.S.). The term “allowable concentration limit” as used herein means a concentration of a toxic fluid such as a hazardous gas which is considered not to cause a health problem for ordinary grown-ups under the condition that they engage themselves in medium labor for 8 hours a day in an environment containing the hazardous gas or the like, for a relatively long term. The term “explosion limit” means a concentration of the target fluid at which explosion takes place if the target fluid is contacted with the air. The term “LD 50” means a dosage that will kill 50% of the dosed subjects within a predetermined time. The term “material labeled with health hazard class 2 or higher defined by NFPA” means a solid, a liquid, or a gas whose hazardous level is evaluated as health hazardous class 2 or higher according to NFPA 704 labeling system, and includes so-called hazardous production materials that are directly used in research laboratories, experiment laboratories, or production processes.

Examples of the harmful material include dimethyl acetamide (allowable concentration limit: 10 ppm, lower explosion limit: 1.8 vol %), monoethanol amine (allowable concentration limit: 3 ppm, lower explosion limit: 5.5 vol %), diethylamine (allowable concentration limit: 10 ppm, lower explosion limit: 1.8 vol %), dimethyl sulfoxide (DMSO) (lower explosion limit: 2.6 vol %), ammonium fluoride (LD 50: 50 mg/kg or less, health hazard class 3 defined by NFPA), and hydroxylamine (health hazard class 2 defined by NFPA). The cleaning composition containing the above harmful material(s) can be used by the inventive cleaning apparatus.

Next, the cleaning apparatus according to the present invention is described referring to the accompanying drawings.

### First Embodiment

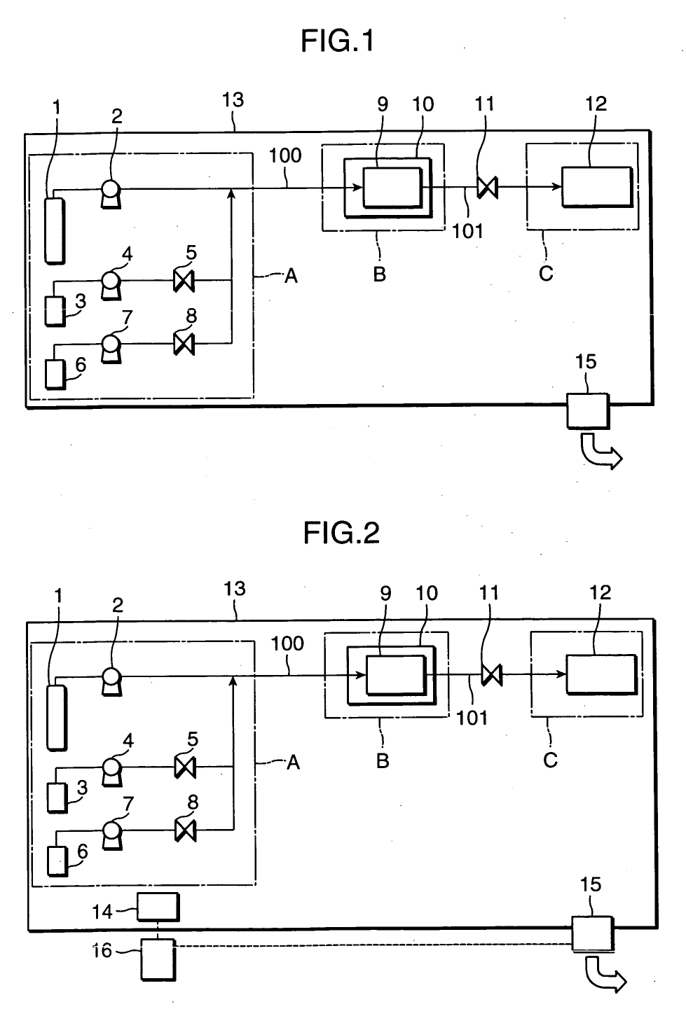

FIG. 1 is an illustration showing a cleaning apparatus in accordance with a first embodiment of the present invention. In FIG. 1, the symbol A denotes high pressure fluid supplying means (high pressure fluid supplying section), B denotes a washing section, and C (specifically, the reference numeral 12) denotes a storing section, respectively. The reference numeral 11 denotes a pressure regulating valve, 15 denotes first exhaust means, 100 and 101 denote pathways, respectively.

The cleaning apparatus shown in FIG. 1 is provided with a carbon dioxide storing tank (storing vessel) 1, a carbon dioxide feeding pump 2, a cleaning component storing tank 3, a cleaning component feeding pump 4, a switching valve 5, a rinsing component storing tank 6, a rinsing component feeding pump 7, and a switching valve 8, which constitute the high pressure fluid supplying section A. The cleaning apparatus is further provided with a high pressure washing vessel 9, and a thermostatic chamber 10, which constitute the washing section B. The cleaning apparatus is also provided with the pressure regulating valve 11 between the washing section B and the storing section C.

The washing section B and a sealed structure 13 each is provided with an opening/closing portion such as a door (not shown) through which an object to be treated (microstructure) is loaded and unloaded. It is needless to say that the opening/closing portion is closed after the object to be treated has been loaded in the washing section B (or unloaded from the washing section B).

A cleaning composition containing carbon dioxide pressurized by the high pressure fluid supplying means A, and hydrogen fluoride as a cleaning component is fed to the washing section B via the pathway 100, as a high pressure fluid. At an appropriate timing before washing with the cleaning composition, an object to be treated (microstructure) is loaded in the washing section B. Contacting the microstructure with the pressurized cleaning composition (hereinafter, sometimes called as “high pressure carbon dioxide”) enables to remove unnecessary materials from the microstructure. The waste stream of high pressure carbon dioxide carrying the unnecessary materials is fed to the storing section 12 via the pathway 101.

In a washing step conducted by the cleaning apparatus, hydrogen fluoride (harmful material) is contained as the cleaning component. However, in the example shown in FIG. 1, the high pressure fluid supplying means (high pressure fluid supplying section) A, the washing section B, the storing section C, and the pressure regulating valve 11 are housed in the sealed structure 13. Thus, all possible sites through which the harmful material may leak are accommodated in the sealed structure 13. With this arrangement, contamination by the harmful materials can be minimized, even if the harmful materials leak out of these possible sites. Further, the inventive cleaning apparatus is provided with the first exhaust means 15 in the sealed structure 13. With this arrangement, the gas in the sealed structure 13 including the harmful materials leaking through the possible sites can be efficiently exhausted out of the cleaning system through the first exhaust means 15. The gas exhausted from the first exhaust means 15 is appropriately treated by detoxification means (not shown), and then the gas free of the harmful materials is emitted in the air.

Two cases are considered with respect to the composition of the leaking gas: one is such that merely hydrogen fluoride gas is contained, and the other is such that hydrogen fluoride and carbon dioxide are mixed. In the following, description is made with respect to the latter case that carbon dioxide gas contains hydrogen fluoride.

In the following, procedures as to how the object to be treated (microstructure) is cleaned with the cleaning apparatus as shown in FIG. 1 are described in detail.

In the cleaning apparatus shown in FIG. 1, a mixed solution of hydrofluoric acid and alcohol is supplied as the cleaning component. The mixed solution is stored in the cleaning component storing tank 3, and alcohol is stored in the rinsing component storing tank 6, respectively. The mixed ratio of the hydrogen fluoride to the alcohol is not specifically limited, and may be optionally determined.

Alternatively, it may be possible to store hydrofluoric acid exclusively in the cleaning component storing tank 3, and to feed alcohol from the rinsing component storing tank 6 when need arises to do so. Further alternatively, it may be possible to feed hydrogen fluoride gas to the high pressure washing vessel 9, in place of feeding hydrofluoric acid.

In implementing the washing step with use of the cleaning apparatus shown in FIG. 1, first, an object to be treated (microstructure) is loaded in the high pressure washing vessel 9 through an opening/closing portion (not shown) thereof. Subsequently, after the carbon dioxide stored in the carbon dioxide storing tank 1 is converted to high pressure carbon dioxide by actuating the carbon dioxide feeding pump 2, the high pressure carbon dioxide is fed to the high pressure washing vessel 9. Meanwhile, the pressure of the high pressure carbon dioxide is regulated, and the temperature of the high pressure washing vessel 9 is set to a predetermined temperature by the thermostatic chamber 10. Then, the cleaning component (mixed solution of hydrofluoric acid and alcohol) is fed from the cleaning component storing tank 3 to the high pressure washing vessel 9 by actuating the cleaning component feeding pump 4. Thus, the washing step is initiated. In the washing step, the high pressure carbon dioxide and the cleaning component may be continuously supplied, or supplied by a batch system in which feeding is suspended when a predetermined pressure is attained, or feeding is suspended for recirculation. Alternatively, a high pressure washing vessel equipped with a heater may be used as the high pressure washing vessel 9. In such an altered arrangement, the thermostatic chamber 10 can be omitted.

After the washing step, the rinsing step is conducted. In the rinsing step, directly mixing the solution containing unnecessary materials such as resist residues, which is obtained after the washing step, with the high pressure carbon dioxide may result in precipitation of the unnecessary materials, or cause particles that have been generated in the washing step to remain on the surface of the microstructure. In view of this, a first rinsing stage of rinsing with a mixture of the high pressure carbon dioxide and alcohol is conducted. In switching over the step from the washing step to the first rinsing stage, there is likelihood that the composition of the solution may be changed by back-mixing in the high pressure washing vessel 9. Using the mixture of alcohol and high pressure carbon dioxide as the first rinsing solution is advantageous in eliminating a drawback such as precipitation of the cleaning component, because the change of the solution composition is suppressed, and a fluctuation of the solubility is minimized. In view of this, it is preferable to make the alcohol to be mixed in the cleaning component, and the alcohol to be used in the first rinsing stage identical to each other.

In the first rinsing stage, feeding of the cleaning component is suspended by actuating the switching valve 5, a rinsing component (alcohol) stored in the rinsing component storing tank 6 is pressurized by actuating the rinsing component feeding pump 7, and the solution after the washing step, namely, waste stream of high pressure carbon dioxide is discharged from the high pressure washing vessel 9 while the pressurized rinsing component and the high pressure carbon dioxide are drawn into the high pressure washing vessel 9. Also, it is preferable to carry out a second rinsing stage of gradually or step-wisely reducing the feeding amount of the alcohol by using the switching valve 8 to charge the high pressure washing vessel 9 with the high pressure carbon dioxide at a final stage. Conducting the second rinsing stage is preferable because charging the high pressure washing vessel 9 with the high pressure carbon dioxide makes it easy to perform a drying step, which follows the rinsing step. The waste stream of high pressure carbon dioxide discharged from the high pressure washing vessel 9 in the washing step and the rinsing step is fed to the storing section 12 for recovery.

A preferred example of the storing section 12 is a gas-liquid separating vessel. Use of the gas-liquid separating vessel is advantageous in separating the waste stream of high pressure carbon dioxide into carbon dioxide gas and a liquefied component, and in recovering the respective components including purification, if necessary, for recycling (carbon dioxide recovering step). Alternatively, the carbon dioxide gas and the liquefied component separated by the gas-liquid separating vessel may be discharged outside of the cleaning system from the sealed structure 13 separately via individual pathways (not shown).

After the rinsing step is completed, returning the pressure in the high pressure washing vessel 9 to atmospheric pressure by actuating the pressure regulating valve 11 enables to instantaneously turn the carbon dioxide fluid remaining in the high pressure washing vessel 9 into carbon dioxide gas. This arrangement enables to dry the objects to be treated (microstructures) such as substrates, without generating stains or the like on the surfaces thereof, and without collapsing fine patterns formed on the surfaces.

### Second Embodiment

FIG. 2 is an illustration showing a cleaning apparatus in accordance with a second embodiment of the present invention. The cleaning apparatus shown in FIG. 2 is provided with first fluid leak detecting means 14 and first exhaust amount controlling means 16, in addition to elements equivalent to the elements in the first embodiment as shown in FIG. 1. It should be noted that the elements in the second through seventh embodiments which are equivalent to those in the first embodiment are denoted at the same reference numerals. The first fluid leak detecting means 14 and the first exhaust amount controlling means 16, and the first exhaust amount controlling means 16 and first exhaust means 15 are electrically connected with each other via wirings, respectively. The wirings are denoted by the dotted lines in FIG. 2. In FIG. 2, a first gas amount detector 14 serves as the first fluid leak detecting means 14.

As shown in FIG. 2, arranging the first gas amount detector 14 in a sealed structure 13 enables an operator to detect carbon dioxide gas containing hydrogen fluoride that has leaked into the sealed structure 13.

The first gas amount detector 14 is adapted for detecting the amount of a predetermined gas or liquid that has leaked from the cleaning apparatus to the sealed structure 13. Specifically, the first gas amount detector 14 as shown in FIG. 2 is adapted to measure the amount of hydrogen-fluoride-containing carbon dioxide gas. The first gas amount detector 14 is constructed in such a manner that the gas in the sealed structure 13 is exhausted outside of the sealed structure 13 through the first exhaust means 15, if, for instance, the concentration of the hydrogen fluoride in the target gas to be measured exceeds a reference value (e.g., 3 ppm), or the concentration of carbon dioxide in the target gas exceeds a reference value (e.g., 5,000 ppm).

When the first gas amount detector 14 detects leakage of the fluid (gas) into the sealed structure 13, data indicative of the leaking amount of the hydrogen-fluoride-containing carbon dioxide gas obtained by the first gas amount detector 14 is sent to the first exhaust amount controlling means 16, which, in turn, controls the first exhaust means 15 to regulate the exhaust amount of the fluid (gas) based on the data. The hydrogen-fluoride-containing carbon dioxide gas exhausted from the first exhaust means 15 is carried to hydrogen fluoride removing means (not shown) for detoxification, and emitted in the air as harmless gas. Examples of the hydrogen fluoride removing means include a filter, activated coal, and an adsorption column charged with an alkali-impregnated activated coal.

The fluid leak detecting means 14 may include a liquid amount detector and a pressure variation detector, other than the first gas amount detector 14. The liquid amount detector is adapted to detect liquid leakage by detecting power energization resulting from the liquid leakage from the cleaning apparatus to the sealed structure 13, and to output a detection signal to an external device. The pressure variation detector is adapted to detect gas leakage by measuring fluctuation of the internal pressure of the sealed structure 13, and to output a detection signal to an external device. Specifically, if the fluid leaks from the cleaning apparatus into the sealed structure 13, the leaking fluid instantaneously turns into gas to thereby raise the internal pressure of the sealed structure 13. If it is detected that the pressure variation amount exceeds a reference value, the hydrogen-fluoride-containing carbon dioxide gas in the sealed structure 13 is exhausted out therefrom.

In the inventive cleaning apparatus, the sealed structure 13 may not be necessarily a completely air-tight structure. As far as a possible gas or liquid which may leak into the sealed structure 13 is of a kind other than a hazardous material which is banned to leak out of the sealed structure 13 even in a trace amount, the sealed structure 13 may be constructed into a roughly or generally air-tight structure such that the fluid such as the gas or the liquid is freely allowed to pass in and out of the sealed structure 13. In such a case, there is no need of forcibly exhausting a large amount of the fluid from the sealed structure 13, which is advantageous from an economical viewpoint.

The cleaning apparatuses in accordance with the first and second embodiments as shown in FIGS. 1 and 2 are constructed such that the washing section B and the storing section C are housed in the sealed structure 13. The cleaning apparatus of the present invention is not limited to these embodiments. Alternatively, sites where it is more likely that harmful materials may leak may be provided in a sealed structure 13, and exhaust means for exhausting the gas out of the sealed structure 13 may be provided individually with respect to each of the possible harmful-material-leaking sites. The altered arrangement is shown as a third embodiment.

### Third Embodiment

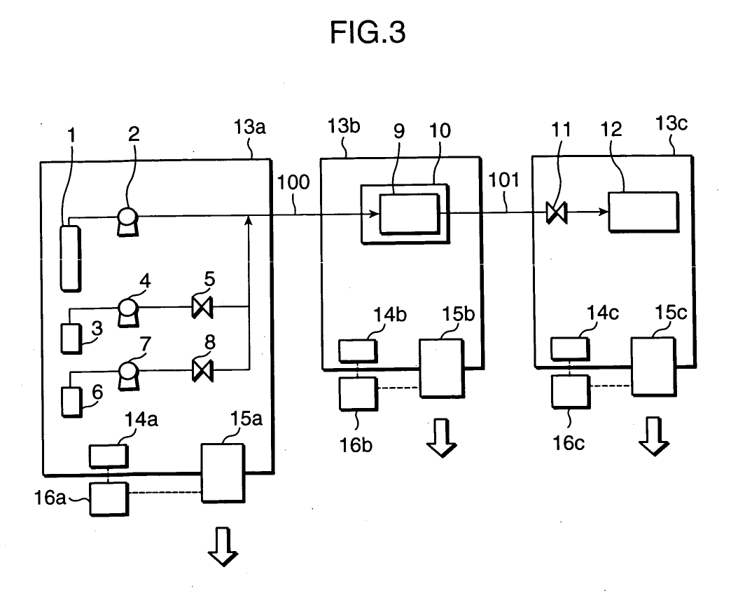

FIG. 3 is an illustration showing a cleaning apparatus in accordance with the third embodiment of the present invention. In FIG. 3, a carbon dioxide storing tank 1, a carbon dioxide feeding pump 2, a cleaning component storing tank 3, a cleaning component feeding pump 4, a switching valve 5, a rinsing component storing tank 6, a rinsing component feeding pump 7, and a switching valve 8 are housed in a sealed unit 13a. A high pressure washing vessel 9, and a thermostatic chamber 10 are housed in a sealed unit 13b. A pressure regulating valve 11 and a storing tank 12 are housed in a sealed unit 13c. The sealed unit 13a is provided with a fluid leak detector 14a, exhaust means 15a, and exhaust amount controlling means 16a. Likewise, the sealed unit 13b is provided with a fluid leak detector 14b, exhaust means 15b, and exhaust amount controlling means 16b. Likewise, the sealed unit 13c is provided with a fluid leak detector 14c, exhaust means 15c, and exhaust amount controlling means 16c.

The arrangement of the elements housed in the respective sealed units 13a, 13b, 13c may be changed depending on the installation condition such as a clean room. For instance, the carbon dioxide storing tank 1, the carbon dioxide feeding pump 2, the cleaning component storing tank 3, and the rinsing component storing tank 6 may be provided in the sealed unit 13a, the cleaning component feeding pump 4, the switching valve 5, the rinsing component feeding pump 7, the switching valve 8, the high pressure washing vessel 9, the thermostatic chamber 10, and the pressure regulating valve 11 may be provided in the sealed unit 13b, and the storing tank 12 may be provided in the sealed unit 13c, respectively. Illustration of the respective arrangements is omitted herein.

The sealed unit 13b is provided with an opening/closing portion such as a door (not shown) to facilitate loading/unloading of objects to be treated in and out of the high pressure washing vessel 9.

### Fourth Embodiment

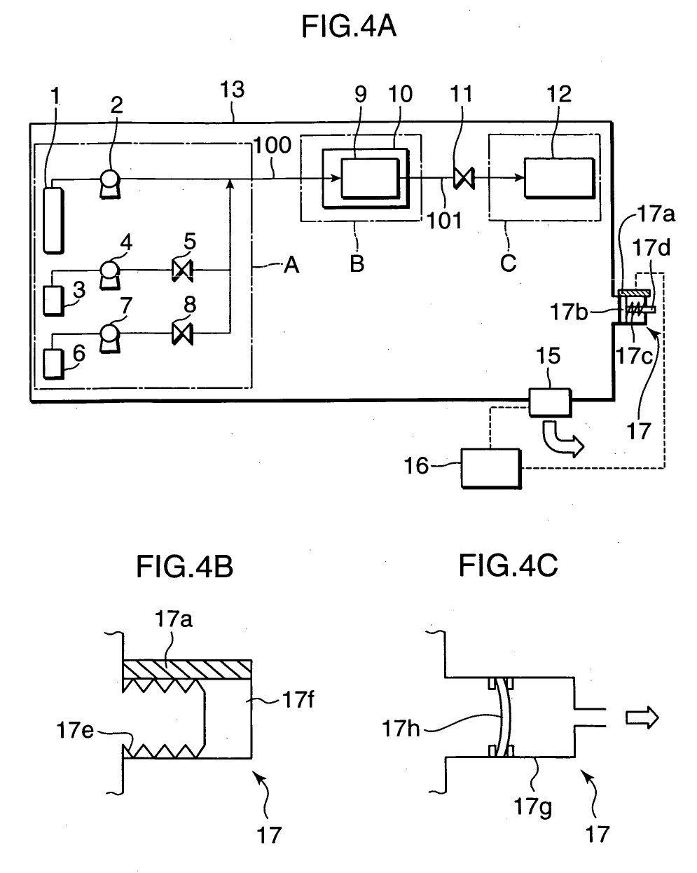

FIG. 4A is an illustration showing a cleaning apparatus in accordance with a fourth embodiment of the present invention. The fourth embodiment is different from the second embodiment shown in FIG. 2 in that volume varying means 17 for varying the volume of a sealed structure is provided, in place of the first gas amount detector 14. In FIG. 4A, the volume varying means 17 and first exhaust amount controlling means 16, the first exhaust amount controlling means 16 and first exhaust means 15 are electrically connected with each other via wirings, respectively. Alternatively, the volume varying means 17 may be provided in the first embodiment shown in FIG. 1.

In FIG. 4A, the reference numeral 17a denotes a level meter, 17b denotes a partition wall, 17c denotes an elastic member, and 17d denotes a piston, respectively. By slidingly moving the partition wall 17b in the volume varying means 17 by actuating the piston 17d, the volume of the volume varying means 17 is varied. Specifically, while the pressure inside a sealed structure 13 is not changed, the partition wall 17b is retained at a predetermined position by the elastic member 17c. Once hydrogen-fluoride-containing carbon dioxide gas leaks into the sealed structure 13, the pressure inside the sealed structure 13 is raised, whereby the partition wall 17b slidingly moves rightward in FIG. 4A in the volume varying means 17.

In a facility of treating high pressure gas, generally, it is predicted that once gas leakage takes place, a possible leakage amount is enormous. In the cleaning apparatus as shown in FIG. 4A, however, the volume of the sealed structure 13 can be varied until the partition wall 17b is moved to a maximal rightward position in FIG. 4A, namely, by the volume of the volume varying means 17. This arrangement enables to suppress a fluctuation of an exhaust amount of the fluid to be exhausted from the first exhaust means 15. There is no likelihood that the exhaust amount is drastically raised. Thus, this arrangement enables to reduce a load to a processing device such as detoxification means (not shown) which is disposed downstream in the fluid flowing direction relative to the first exhaust means 15.

Further, as shown in FIG. 4A, the volume varying means 17 and the first exhaust amount controlling means 16, and the first exhaust amount controlling means 16 and the first exhaust means 15 are electrically connected with each other via wirings, respectively. If the gas leaks into the sealed structure 13, the level meter 17a measures a sliding amount of the partition wall 17b, and sends data indicative of the sliding amount to the first exhaust amount controlling means 16, which, in turn, controls the first exhaust means 15 to regulate the exhaust amount based on the data. The hydrogen-fluoride-containing carbon dioxide gas exhausted from the first exhaust means 15 is carried to the unillustrated processing device (detoxification means) for detoxification, and is emitted in the air as harmless gas. In other words, the volume varying means 17 shown in FIG. 4A functions as the first fluid leak detecting means 14 shown in FIG. 2. It should be appreciated that the following description is made based on that the element corresponding to the “fluid leak detecting means” is not provided with a function as the “volume varying means” for sake of easy explanation.

Examples of the volume varying means 17 include arrangements as shown in FIGS. 4B and 4C, other than the arrangement as shown in FIG. 4A.

In FIG. 4B, the reference numeral 17a denotes a level meter, 17e denotes a bellow-shaped elastic member, and 17f denotes a frame body, respectively. The bellow-shaped elastic member 17e is transversely expandable and contractible in the space defined by the frame body 17f in FIG. 4B. In FIG. 4C, the reference numeral 17g denotes a projecting section, and 17h denotes a rupture plate, respectively. The rupture plate 17h is arranged in the projecting section 17g at such a position as to separate the space of the projecting section 17g into two parts, and is configured to rupture when a difference in pressure between the two parts in the projecting section 17g exceeds a predetermined value (e.g., 0.2 MPa). When the rupture plate 17g ruptures, the harmful gas such as the hydrogen-fluoride-containing carbon dioxide gas is carried to an unillustrated processing device (detoxification means) provided outside of the sealed structure 13 via an opening in the projecting section 17g.

The volume varying means 17 shown in FIGS. 4A and 4B are each equipped with the level meter 17a to detect a fluctuation of the volume of the volume varying means 17. Alternatively, any configuration may be applicable as far as the internal volume of the volume varying means is variable to mitigate drastic increase of the exhaust amount of the fluid through the first exhaust means 15.

### Fifth Embodiment

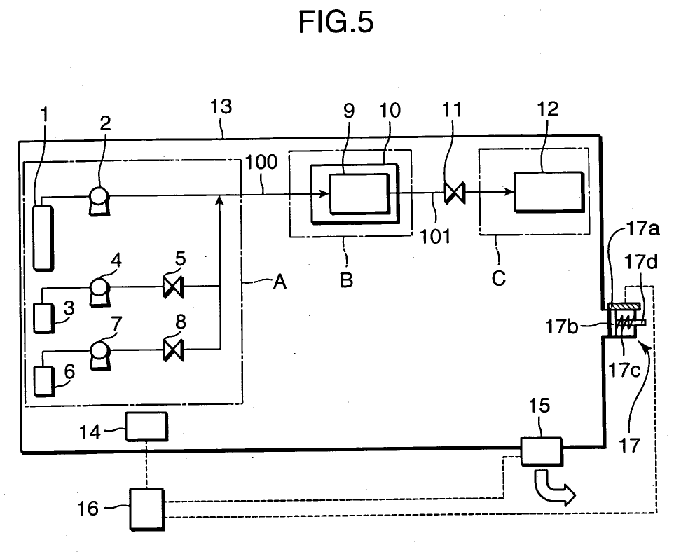

FIG. 5 is an illustration showing a cleaning apparatus in accordance with a fifth embodiment of the present invention. The cleaning apparatus shown in FIG. 5 is different from the cleaning apparatus shown in FIG. 1 in that first fluid leak detecting means 14, exhaust amount controlling means 16, and volume varying means 17 are provided in addition to elements equivalent to the elements shown in FIG. 1. The elements in FIG. 5 which are equivalent to those in FIG. 1 are denoted at the same reference numerals. The first fluid leak detecting means 14 and the exhaust amount controlling means 16, the volume varying means 17 and the exhaust amount controlling means 16, and exhaust means 15 and the exhaust amount controlling means 16 are electrically connected with each other via wirings, respectively. The wirings are represented by the dotted lines in FIG. 5.

The cleaning apparatus as shown in FIG. 5 is provided with the single exhaust amount controlling means 16 which receives data from the first fluid leak detecting means 14 and the volume varying means 17. Alternatively, plural fluid leak detecting means may be provided, and plural exhaust amount controlling means may be provided in correspondence to the plural fluid leak detecting means.

### Sixth Embodiment

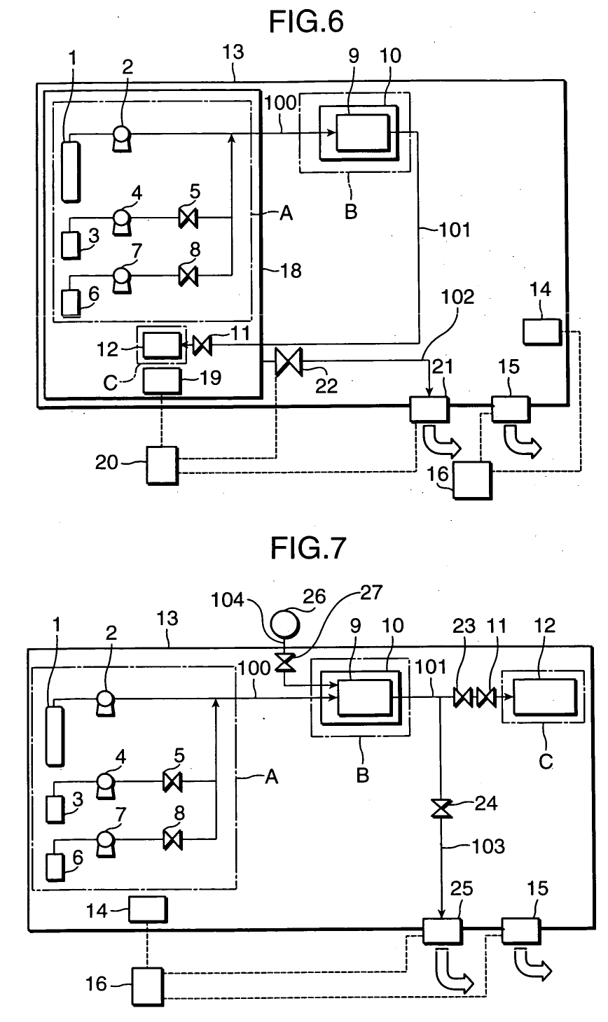

FIG. 6 is an illustration showing a cleaning apparatus in accordance with a sixth embodiment of the present invention. The sixth embodiment is different from the second embodiment shown in FIG. 2 in that high pressure fluid supplying means (high pressure fluid supplying section) A, and a storing section C are housed in a second sealed structure 18. In FIG. 6, the reference numeral 19 denotes second fluid leak detecting means, 20 denotes second exhaust amount controlling means, 21 denotes second exhaust means, 22 denotes an opening/closing valve, and 102 denotes a pathway, respectively.

As mentioned above, there is a possibility that hydrogen-fluoride-containing carbon dioxide gas may leak from all the possible sites including the high pressure fluid supplying section A, the washing section B, and the storing section C. In the present invention, damage resulting from leakage of hydrogen fluoride can be suppressed by housing the high pressure fluid supplying section A, the washing section B, and the storing section C in the sealed structure. However, there is considered a fact that the objects to be treated are frequently loaded in and unloaded out of the washing section B. Accordingly, if the hydrogen-fluoride-containing carbon dioxide gas remains in the washing section B, it is likely that the gas may be vaporized in loading/unloading the objects to be treated in and out of the washing section B, and resultantly leak out of the washing section B, which may give adverse effect on the cleaning operation.

On the other hand, the high pressure fluid supplying sections A and the storing section C are less frequently opened and closed, as compared with the washing section B. Therefore, it is less likely that the hydrogen-fluoride-containing carbon dioxide gas may leak from these sections A and C. However, the high pressure fluid supplying section A and the storing section C store a considerable amount of hydrogen fluoride, as compared with the washing section B. Therefore, once leakage takes place in the sections A and C, a serious damage will be unavoidable.

In view of the above, in the present invention, the high pressure fluid supplying section A and the storing section C are housed in the second sealed structure 18, as shown in FIG. 6. Accommodating the sections A and C in the double-sealed structure unit enables to minimize possible damage due to leakage of the hydrogen-fluoride-containing carbon dioxide gas.

It is recommended to house the washing section B in the second sealed structure 18, as well as the sections A and C, from a viewpoint of minimizing possible damage due to leakage of the hydrogen-fluoride-containing carbon dioxide gas. However, it is not desirable to house the washing section B in the second sealed structure 18, considering the frequency and operability in loading/unloading the objects to be treated in and out of the washing section B. Namely, if the washing section B is housed in the second sealed structure 18, there rises a necessity that an opening/closing portion (not shown) of the second sealed structure 18 is opened each time an object to be treated is loaded in and unloaded out of the washing section B, which considerably reduces an effect by providing the second sealed structure 18.

It is preferable to provide the second fluid leak detecting means 19 in the second sealed structure 18 to promptly detect leakage of the fluid in the second sealed structure 18. If the fluid leakage is detected by the second fluid leak detecting means 19, data indicative of the fluid leakage detected by the second fluid leak detecting means 19 is sent to the second exhaust amount controlling means 20, which, in turn, controls the second exhaust means 21 to regulate the exhaust amount of the fluid. In discharging the fluid (gas) out of the second sealed structure 18, the open/close valve 22 provided at an appropriate position in the gas exhaust pathway 102 is opened. While the gas in the second sealed structure 18 is not exhausted, the open/close valve 22 is closed, whereby sealability of the second sealed structure 18 is secured.

Similar to the first fluid leak detecting means 14 in the foregoing embodiments, examples of the second fluid leak detecting means 19 include a gas amount detector, a liquid amount detector, and a pressure fluctuation detector.

In the cleaning apparatus shown in FIG. 6, the high pressure fluid supplying means (high pressure fluid supplying section) A and the storing section C are housed in the second sealed structure 18. Alternatively, the high pressure fluid supplying section A and the storing section C may be individually housed in a corresponding sealed unit. Further, in FIG. 6, the first exhaust amount controlling means 16 is provided to control the first exhaust means 15, and the second exhaust amount controlling means 20 is provided to control the second exhaust means 21, respectively. Alternatively, single controlling means may be provided to control both of the first exhaust means 15 and the second exhaust means 21, in place of the first exhaust amount controlling means 16 and the second exhaust amount controlling means 20.

### Seventh Embodiment

FIG. 7 is an illustration showing a cleaning apparatus in accordance with a seventh embodiment of the present invention. The seventh embodiment is different from the second embodiment in that a waste fluid pathway 103 is provided, in addition to the elements shown in FIG. 2, to discharge a waste high pressure fluid stream from a washing section B outside of a sealed structure 13 without passing through a storing section C. In FIG. 7, the reference numerals 23, 24, 27 denote opening/closing valves, 25 denotes exhaust means, 26 denotes cleaning fluid supplying means for supplying a cleaning fluid to a high pressure washing vessel 9, and 104 denotes a pathway, respectively.

In FIG. 7, the cleaning fluid supplying means 26 is arranged outside of the sealed structure 13. This arrangement is effective in the case where a cleaning fluid to be supplied to the high pressure washing vessel 9 does not contain a harmful material, and the supply amount of the cleaning fluid is large. In the case where the cleaning fluid itself contains a harmful material, providing a part or entirety of the cleaning fluid supplying means 26 in the sealed structure 13 enables to minimize a possible damage resulting from leakage of the harmful material.

In the cleaning apparatus as shown in FIG. 7, the pathway 101 of connecting the washing section B and the storing section C is ramified at a certain position, so that the waste fluid can be discharged from the washing section B outside of the sealed structure 13 via the waste fluid pathway 103 without passing through the storing section C. Specifically, the opening/closing valves 23 and 24 are arranged at downstream positions from the ramified portion (merging portion) of the pathway 101 and the waste fluid pathway 103, respectively, and manipulating the opening/closing valves 23 and 24 makes it possible to control changeover of the fluid passage to be exhausted from the washing section B.

After the object to be treated is washed in the washing section B, the waste high pressure fluid carrying the unnecessary materials which have been deposited on the object to be treated is fed to the storing section C via the pathway 101 by closing the opening/closing valve 24, and opening the opening/closing valve 23. At this time, gas of a pressure of not smaller than an atmospheric pressure remains in the high pressure washing vessel 9. There is likelihood that the gas contains hydrogen fluoride. Accordingly, opening the opening/closing portion of the washing section B to load/unload the object to be treated in and out thereof in a state that the gas remains in the high pressure washing vessel 9 may resultantly lead to leakage of the hydrogen-fluoride-containing carbon dioxide gas out of the washing section B, and may diffuse the gas in the sealed structure 13.

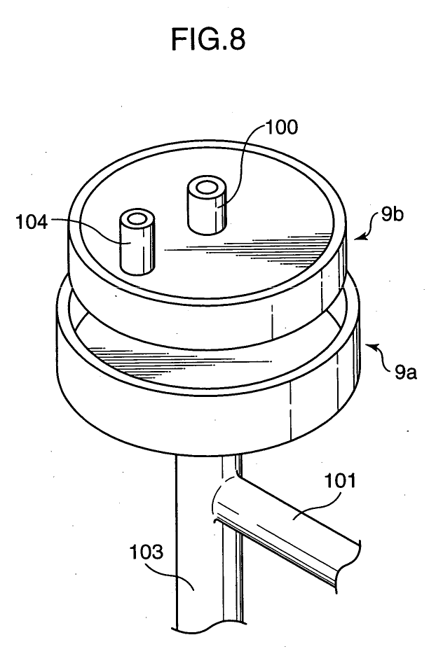

In view of the above, the cleaning apparatus as shown in FIG. 7 is constructed in such a manner that the waste fluid pathway 103 is provided to discharge the waste high pressure fluid from the washing section B outside of the sealed structure 13 without passing through the storing section C, and after the waste high pressure fluid in the washing section B is fed to the storing section C, the opening/closing valve 23 is closed, followed by opening of the opening/closing valve 24 to discharge the hydrogen-fluoride-containing carbon dioxide gas remaining in the washing section B outside of the sealed structure 13 through the exhaust means 25. This arrangement makes it possible to prevent leakage of the hydrogen-fluoride-containing carbon dioxide gas into the sealed structure 13 to thereby secure safety operation of the cleaning apparatus. Further, it is preferable to provide a ramifying site of the waste fluid pathway 103 from the pathway 101 in proximity to the high pressure washing vessel 9. The arrangement as to how the waste fluid pathway 103 is ramified from the pathway 101 is shown in FIG. 8, which will be describe later in detail. In the cleaning apparatus as shown in FIG. 7, similar to the foregoing embodiments, the exhaust means 25 and the first exhaust amount controlling means 16 are electrically connected with each other to allow the first exhaust amount controlling means 16 to control the operation of the exhaust means 25.

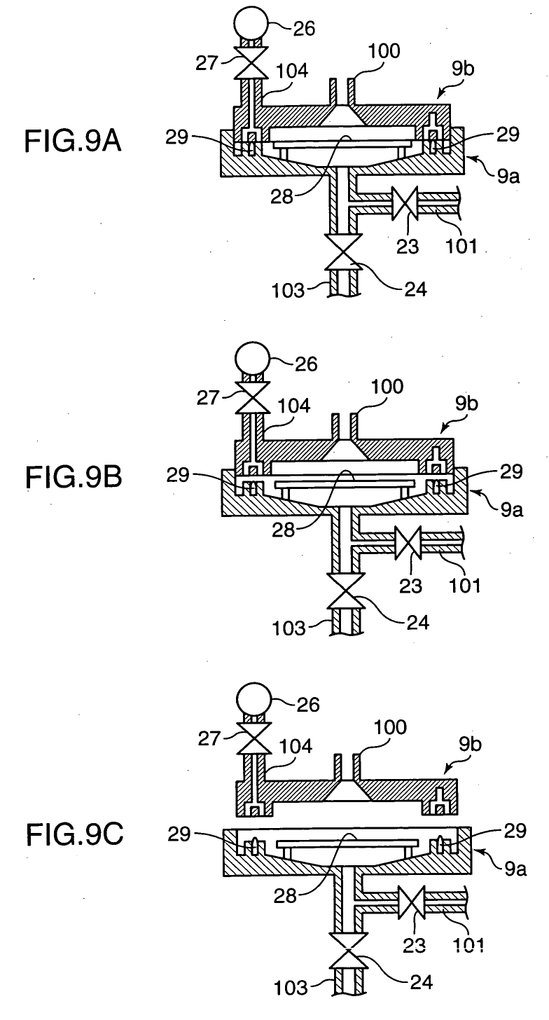

It is preferable that the cleaning fluid supplying means 26 is provided to the washing section B, as shown in FIG. 7 in the inventive cleaning apparatus. Procedures as to how the washing section B is washed by the cleaning fluid supplied from the cleaning fluid supplying means 26 will be described in detail referring to FIGS. 8 through 9C.

FIG. 8 is a perspective view showing an example of an external appearance of the high pressure washing vessel 9 provided in the washing section B in FIG. 7. FIG. 8 shows a state that a cover provided in the high pressure washing vessel 9 is opened. In FIG. 8, the reference numeral 9a denotes a main body of the high pressure washing vessel 9, 9b denotes the cover thereof, 100, 101, 103, 104 denote pathways, respectively. Elements in FIG. 8 which are equivalent to those in FIG. 7 are denoted at the same reference numerals. The external configuration of the high pressure washing vessel 9 used in the inventive cleaning apparatus is not limited to the circular shape in cross section, as shown in FIG. 8. A square shape, an oval shape in cross section, and other shape may be applicable as the external configuration of the high pressure washing vessel 9 according to needs. A thermostatic chamber 10 is omitted in FIG. 8.

FIGS. 9A, 9B, 9C are cross-sectional views of the high pressure washing vessel 9 shown in FIG. 8. The cleaning fluid supplying means 26 and the opening/closing valve 27 are provided at appropriate positions in the pathway 104, as shown in FIG. 8. In FIGS. 9A, 9B, 9C, the reference numeral 28 denotes an object to be treated (microstructure), and 29 denotes a seal member. As shown in FIG. 7, the opening/closing valve 23 is provided in the pathway 101, and the opening/closing valve 24 is provided in the pathway 103, respectively.

FIG. 9A shows a step of washing an object to be treated (microstructure) 28, FIG. 9B shows a step of washing the high pressure washing vessel 9, and FIG. 9C shows a step of unloading the object to be treated (microstructure) 28 out of the high pressure washing vessel 9.

Referring to FIG. 9A, high pressure carbon dioxide supplied from the carbon dioxide storing tank 1 through the pathway 100 is contacted with the object to be treated (microstructure) 28 loaded in the high pressure washing vessel 9 to remove unnecessary materials deposited on the object to be treated (microstructure) 28. The waste of high pressure fluid stream carrying the unnecessary materials is fed to the storing section C (not shown) through the pathway 101. As described above with reference to FIG. 7, part of the waste high pressure fluid is gasified, and the resultant hydrogen-fluoride-containing carbon dioxide gas remains in the high pressure washing vessel 9. In view of this, the following measure is taken. Specifically, the opening/closing valve 23 is closed, followed by opening of the opening/closing valve 24, and then, a small clearance is defined between the vessel main body 9a and the cover 9b of the high pressure washing vessel 9, as shown in FIG. 9B. Subsequently, the opening/closing valve 27 is opened to feed the cleaning fluid from the cleaning fluid supplying means 26 into the high pressure washing vessel 9 via the pathway 104. Thereby, the interior of the high pressure washing vessel 9 is washed with the cleaning fluid, and the cleaning fluid along with the hydrogen-fluoride-containing carbon dioxide gas remaining in the high pressure washing vessel 9 is discharged out of the sealed structure 13 via the pathway 103 through the exhaust means 25 (not shown).

In the conventional arrangement, there is likelihood that a hydrogen-fluoride-based compound deposits in the vicinity of a seal member corresponding to the seal member 29 for securing sealability of a high pressure washing vessel, and contamination may occur resulting from the deposited compound. However, in the cleaning apparatus as shown in FIGS. 7 through 9C, the cleaning fluid supplying means 26 is provided for washing the high pressure washing vessel 9 in the present invention. This arrangement is advantageous in washing off a hydrogen-fluoride-based compound that may deposit in the vicinity of the seal member 29 to thereby suppress generation of contamination. In view of this, it is preferable to feed the cleaning fluid from such a position as to efficiently wash the seal member 29 provided in the high pressure washing vessel 9.

It is necessary to set a relatively small distance between the lower surface of the cleaning fluid supplying means 26 and the upper surface of the seal member 29, as shown in FIG. 9B, to define the small space between the vessel main body 9a and the cover 9b of the high pressure washing vessel 9, rather than opening up the cover 9b completely away from the vessel main body 9a, as shown in FIG. 9C. This is preferable because completely opening the cover 9b leads to leakage of the hydrogen-fluoride-containing carbon dioxide gas remaining in the high pressure washing vessel 9.

Examples of the cleaning fluid include an alcohol such as ethanol, and a gas such as nitrogen gas.

After the interior of the high pressure washing vessel 9 is washed with the cleaning fluid, as shown in FIG. 9C, the cover 9b of the high pressure washing vessel 9 is opened to allow an operator to unload the object to be treated (microstructure) 28 from the high pressure washing vessel 9. In the example of FIGS. 9A through 9C, the interior of the high pressure washing vessel 9 is washed in a state that the object to be treated (microstructure) 28 has been loaded in the high pressure washing vessel 9. Alternatively, the interior of the high pressure washing vessel 9 may be washed after the object to be treated (microstructure) 28 has been unloaded from the high pressure washing vessel 9.

### Eighth Embodiment

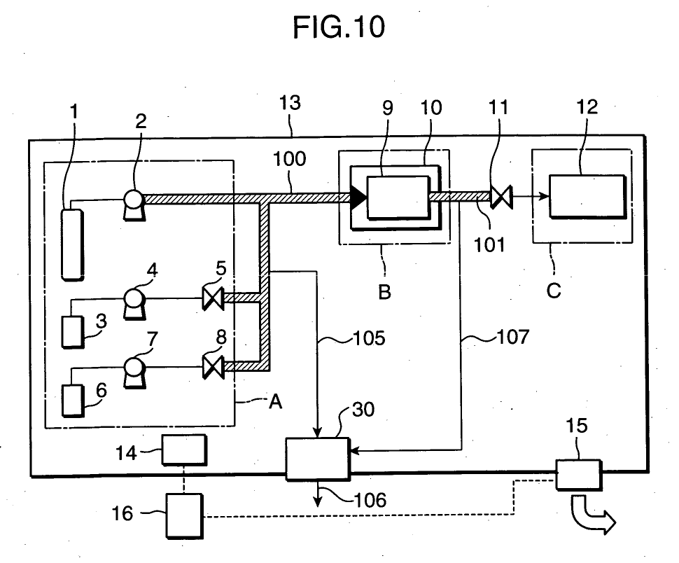

FIG. 10 is an illustration showing a cleaning apparatus in accordance with an eighth embodiment of the present invention. The eighth embodiment is different from the second embodiment shown in FIG. 2 in that buffer means 30 is additionally provided. The buffer means 30 includes second fluid leak detecting means and second exhaust means (both of the elements are not shown in FIG. 10). High pressure fluid supplying means (high pressure fluid supplying section) A and a washing section B, and the washing section B and a storing section C are connected with each other by a double-layered pipe serving as a double-layered structure unit, respectively. The double-layered pipe comprises a layer for passing a high pressure fluid, and an outer layer which encloses the fluid passing layer, and is shown by the hatched portions in FIG. 10. The outer layer of the double-layered pipe, and the buffer means 30 are connected with each other by a pathway 105 or a pathway 107.

FIG. 10 illustrates a case that the washing section B and a pressure regulating valve 11 are connected with each other by the double-layered pipe. Alternatively, the pressure regulating valve 11 and the storing section C may be connected with each other by the double-layered pipe, as well as connecting the washing section B and the pressure regulating valve 11 with each other by the double-layered pipe.

High pressure hydrogen-fluoride-containing carbon dioxide gas flows through the pipe (pathway) 100 for connecting the high pressure fluid supplying section A and the washing section B. Therefore, it is recommended to use a double-layered pipe as the pipe for connecting the high pressure fluid supplying section A and the washing section B to maximally suppress damage by. contamination resulting from leakage of harmful materials. This is recommended because the double-layered structure having the outer layer enclosing the fluid passing layer is advantageous in keeping the hydrogen-fluoride-containing carbon dioxide gas from leaking through the pipe and in keeping the leaking gas from diffusing in the sealed structure 13.

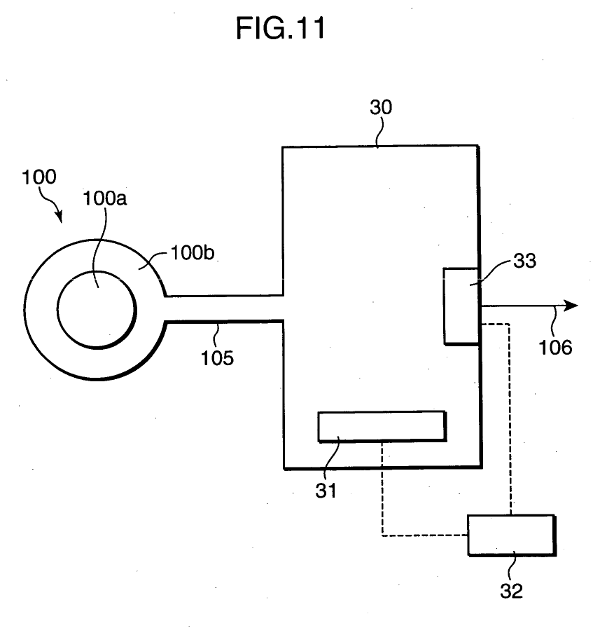

FIG. 11 illustrates a state as to how the outer layer of the pipe 100 and the buffer means 30 are connected with each other in the case where the double-layered pipe is used as the pipe 100 for connecting the high pressure fluid supplying section A and the washing section B.

FIG. 11 is a cross-sectional view showing a state as to how the buffer means 30 is connected with the pipe 100 for connecting the high pressure fluid supplying section A and the washing section B. In FIG. 11, the reference numeral 100a denotes a layer for passing a high pressure fluid, 100b is an outer layer enclosing the fluid passing layer 100a, 31 denotes second fluid leak detecting means, 32 denotes second exhaust amount controlling means, and 33 denotes second exhaust means, respectively. Elements in FIG. 11 which are equivalent to those in FIG. 10 are denoted at the same reference numerals.

In FIG. 11, the second fluid leak detecting means 31 is provided in the buffer means 30. Alternatively, the second fluid leak detecting means 31 may be provided in the outer layer 100b.

The hydrogen-fluoride-containing carbon dioxide gas to be supplied from the high pressure fluid supplying means A passes through the fluid passing layer 100a of the pipe 100. The outer layer 100b is provided around the fluid passing layer 100a. With this arrangement, if the hydrogen-fluoride-containing carbon dioxide gas leaks through the fluid passing layer 100a, the gas is diffused in the outer layer 100b, and stays in the buffer means 30 through the pathway 105. The second fluid leak detecting means 31 provided in the buffer means 30 detects the gas leakage inside the buffer means 30, and sends data indicative of a detection result to the second exhaust amount controlling means 32, which, in turn, controls the second exhaust means 33 to regulate the exhaust amount of the gas based on the data.

Similar to the first fluid leak detecting means 14 in the foregoing embodiments, examples of the second fluid leak detecting means 31 in the eighth embodiment include a gas amount detector, a liquid amount detector, and a pressure fluctuation detector.

As described above, the double-layered pipe comprising the fluid passing layer 100a for passing a high pressure fluid, and the outer layer 100b enclosing the fluid passing layer 100a is used as a pipe arrangement for connecting the high pressure fluid supplying section A and the washing section B with each other, and the outer layer 100b is connected with the buffer means 30 provided with the second fluid leak detecting means 31 and the second exhaust means 33. This arrangement enables to provide effective leak-proof measure with respect to possible sites where harmful materials may leak.

Further, as shown in FIG. 10, it is recommended to construct the cleaning apparatus in such a manner that the washing section B and the storing section C are connected with each other by the double-layered pipe and to connect the double-layered pipe with the buffer means 30 by the pathway 107. This arrangement is effective in further suppressing leakage of hydrogen-fluoride-containing carbon dioxide gas.

Various materials are usable as materials constituting the double-layered pipe. Examples of the materials superior in stress resistance are metallic materials such as stainless steel SUS316L and SUS304. Examples of the materials superior in chemical resistance are resin materials such as polyethylene and polypropylene.

The double-layered structure in the inventive cleaning apparatus is not limited to the double circular shape in cross section, as shown in FIG. 11. Alternatively, an outer pipe constituting the outer layer 100b may have a bellow shape to be expandable and contractible. As a further altered arrangement, an elastic material having elasticity may be used as a material for the outer layer 100b. Decision as to whether the conventional double-layered pipe arrangement as shown in FIG. 11 or the other pipe arrangement is used is optionally made, considering feasibility in construction, maintenance service, costs, and the like.

As described above, according to the present invention, provided is the cleaning apparatus for cleaning objects to be treated by contacting the objects to be treated with a high pressure fluid stream of a cleaning composition containing a cleaning component as an essential ingredient to remove unnecessary materials deposited on the objects to be treated to minimize contamination by harmful materials which may leak through the cleaning apparatus to thereby suppress adverse effect on human beings.

This application is based on Japanese Patent Application No. 2003-273587 filed on Jul. 11, 2003, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A cleaning apparatus for cleaning an object to be treated by contacting the object to be treated with a high pressure fluid of a cleaning composition containing a cleaning component as an essential ingredient, the apparatus comprising:
high pressure fluid supplying means for supplying the high pressure fluid of the cleaning composition;
a high pressure washing vessel for removing unnecessary materials deposited on the object to be treated by contacting the object to be treated with the high pressure fluid of the cleaning composition therein;
a storing vessel for storing a waste high pressure fluid of the cleaning composition carrying the unnecessary materials therein; and
a sealed structure for sealably housing the high pressure fluid supplying means, the high pressure washing vessel, and the storing vessel therein,
the sealed structure including first exhaust means for exhausting a gas remaining in the sealed structure therefrom.

2. The apparatus according to claim 1, wherein the sealed structure includes a thermostatic chamber for accommodating the high pressure washing vessel therein.

3. The apparatus according to claim 1, wherein the sealed structure includes a pressure regulating valve provided between the high pressure washing vessel and the storing vessel.

4. The apparatus according to claim 1, wherein the sealed structure includes:
first fluid leak detecting means for detecting leakage of the fluid into the sealed structure; and
first exhaust amount controlling means for controlling the first exhaust means to regulate an amount of the gas to be exhausted from the sealed structure based on data acquired by the first fluid leak detecting means.

5. The apparatus according to claim 1, wherein the sealed structure includes volume varying means for varying the volume of the sealed structure.

6. The apparatus according to claim 5, wherein the volume varying means includes first exhaust amount controlling means for controlling the first exhaust means to regulate an amount of the gas to be exhausted from the sealed structure based on data acquired by the volume varying means.

7. The apparatus according to claim 1, wherein the sealed structure includes:
a second sealed unit for sealably housing the high pressure fluid supplying means and the storing vessel therein;
second fluid leak detecting means for detecting leakage of the fluid into the second sealed unit;
second exhaust means for exhausting a gas remaining in the second sealed unit therefrom; and
second exhaust amount controlling means for controlling the second exhaust means to regulate an amount of the gas to be exhausted from the second sealed unit based on data acquired by the second fluid leak detecting means.

8. The apparatus according to claim 1, further comprising cleaning fluid supplying means for supplying a cleaning fluid to the high pressure washing vessel to wash the high pressure washing vessel.

9. The apparatus according to claim 8, further comprising a pathway for connecting the high pressure washing vessel and the storing vessel, wherein the pathway is ramified at a certain position in such a manner as to exhaust at least a part of the fluid from the high pressure washing vessel out of the sealed structure without passing through the storing vessel.

10. The apparatus according to claim 1, wherein the sealed structure includes:
a double-layered pipe for connecting the high pressure fluid supplying means and the high pressure washing vessel; and
a double-layered pipe for connecting the high pressure washing vessel and the storing vessel, each of the double-layered pipe having a layer for passing the high pressure fluid, and an outer layer enclosing the fluid passing layer.

11. The apparatus according to claim 10, further comprising buffer means, and a pipe for connecting the buffer means and the outer layer of the double-layered pipe.
